(19) United States
(12) Patent Application Publication
(10) Pub. No.: US 2018/0173617 A1
(43) Pub. Date: Jun. 21, 2018

(54) SYSTEM AND METHOD FOR TESTING PROGRAM USING USER INTERACTION REPLAY

(71) Applicant: Google Inc., Mountain View, CA (US)

(72) Inventor: Tian Tian, Milpitas, CA (US)

(21) Appl. No.: 15/384,914

(22) Filed: Dec. 20, 2016

(51) Int. Cl. G06F 11/36; G06F 9/44

(52) U.S. Cl. CPC G06F 11/3692; G06F 9/4443

(57) ABSTRACT

Aspects of the disclosed technology include a method including retrieving, by a computing device, a test case for a software program, the test case comprising indications of input signals of a plurality of user interactions and first output artifacts generated by the software program in response to input signals; and sequentially replaying the plurality of user interactions by: identifying a current user interaction of the plurality of user interactions; transmitting, to the software program, data representative of input signals corresponding to the current user interaction, to replay the current user interaction; comparing a current first output artifact of the plurality of first output artifacts with a current second output artifact generated by the software program in response to receiving the data representative of the input signals; and determining whether replaying of the current user interaction succeeds before identifying a next user interaction as the current user interaction.

### TECHNICAL FIELD

The present disclosure is related generally to testing software programs, and more particularly to generating and testing software programs using user interaction replay.

### BACKGROUND

Software testing is useful for readily identifying errors and improving usability. For example, in order to ensure existing user interactions in a client application are not harmed by changes to the client application, a client device, or backend systems, developers usually test user interactions before committing changes. Some tools for testing user interactions require a developer to supply predefined test cases, expected outputs of the test cases, and programming logic to execute the test cases, which may take substantial time, skill, and in-depth developer knowledge even when using these tools. In addition, developer designed test cases are limited to circumstances predicted by the developer, and may not reflect actual use of the application. Related art testing frameworks attempt to address these problems by recording interactions with a software program, and storing the program's output response. The recorded interactions are later replayed, and the program's output response to the actual replayed interactions is compared with the expected, stored output response.

However, in the related art solutions, certain changes to the output may be consistent with proper execution of the program based on differences in circumstances of the recording and the replaying, yet false negatives to the test cases may occur. Further, in the related art, the recording must be initiated on a testing device. Accordingly, there is need to determine whether actual results satisfy the expected results based on consistency between the actual and expected results, as well as capturing test cases in a decentralized manner.

### SUMMARY

Briefly described, and according to one embodiment, aspects of the present disclosure generally relate to software test generation and execution. Certain implementations may include a method including: retrieving, by a computing device, a test case for a software program, the test case comprising indications of input signals of a plurality of user interactions and first output artifacts generated by the software program in response to input signals of respective user interactions of the plurality of first user interactions; and sequentially replaying, by the computing device, the plurality of user interactions by: identifying a current user interaction of the plurality of user interactions; transmitting, by the computing device and to the software program, data representative of input signals corresponding to the current user interaction, to replay the current user interaction; comparing, by the computing device, a current first output artifact of the plurality of first output artifacts with a current second output artifact generated by the software program in response to receiving the data representative of the input signals corresponding to the current user interaction, the current first output artifact corresponding to the current user interactions; and determining, by the computing device, whether replaying of the current user interaction succeeds before identifying a next user interaction as the current user interaction.

The determining may include: determining whether the current second output artifact is consistent with the current first output artifact, and determining that the replaying of the current user interaction succeeds in response to the comparing indicating that the current second output artifact is consistent with the current first output artifact.

The sequentially replaying may further include, responsive to determining that the replaying of the current user interaction succeeds, replaying the next user interaction.

The determining whether the current second output artifact is consistent with the current first output artifact may include identifying contextual differences between the current second output artifact and the current first output art as expected differences.

The test case may further include identification of contextual differences in the output artifacts.

The determining may include determining that the replaying of the current user interaction has failed in response to the comparing indicating that the current second output artifact is fundamentally different from the current first output artifact.

The determining may include determining that the replaying of the current user interaction has failed in response an error in the software program.

The test case may further include timestamps corresponding to the user interactions of the plurality of user interactions, and the sequentially replaying may include sequentially replaying the recorded plurality of user interactions in an order corresponding to the captured timestamps.

Certain implementations may include a system including: a processor; and a memory having stored thereon computer program code that, when executed by the processor controls the processor to implement: a record reader configured to retrieve a test case for a software program, the test case comprising indications of input signals of a plurality of user interactions sent to the software program and a plurality of first output artifacts generated by the software program in response to input signals of respective user interactions of the plurality of user interaction; a record player configured to sequentially replay the plurality of user interactions by: identifying a current user interaction of the plurality of user interactions; transmitting, to the software program, data representative of input signals corresponding to the current user interaction, to replay the current user interaction; comparing, by the computing device, a current first output artifact of the plurality of first output artifacts with a current second output artifact generated by the software program in response to receiving the data representative of the input signals corresponding to the current user interaction, the current first output artifact corresponding to the current user interactions; and determining, by the computing device, whether replaying of the current user interaction succeeds before identifying a next user interaction as the current user interaction.

The record player may be further configured to sequentially replay the plurality of user interactions by, responsive to determining that the replaying of the current user interaction succeeds, replaying the next user interaction.

The determining may include: determining whether the current second output artifact is consistent with the current first output artifact, and determining that the replaying of the current user interaction succeeds in response to the comparing indicating that the current second output artifact is consistent with the current first output artifact.

The determining whether the current second output artifact is consistent with the current first output artifact may include identifying contextual differences between the current second output artifact and the current first output art as expected differences.

The record player may be configurable to identify contextual differences.

The determining may include determining that the replaying of the current user interaction has failed in response to the comparing indicating that the current second output artifact is fundamentally different from the current first output artifact.

The record player may be further configured to, responsive to determining that the replaying of the current user interaction has failed, output a notice of the failure and cease the sequential replay.

The test case may further include timestamps corresponding to respective user interactions of the plurality of user interactions, and the record player may be configured to sequentially replay the plurality of user interactions in an order corresponding to the captured timestamps.

Certain implementations may include a method including: receiving, by a computing device from an external device, an instruction to generate a test case for a software program; recording, by the computing device and in response to receiving the instruction, indications of input signals of a plurality of relevant user interactions with the software program; capturing, by the computing device, first output artifacts generated by the software program in response to the input signals of the plurality of relevant user interactions; and transmitting, by the computing device and to the external device, the recorded indications of the input signals of the plurality of relevant user interactions in connection with the captured first output artifacts as the generated test case.

The recording may include: identifying a plurality of user interactions, determining whether each user interaction of the plurality of identified user interactions is relevant, and recording a subset of the plurality of user interactions determined to be relevant as the plurality of relevant user interactions.

The determining may include determining that an identified user interaction of the plurality of user interactions is relevant in response to the software program generating an output artifact in response to input signals of the identified user interaction.

The method may further include: recording, by the computer device, timestamps corresponding to respective user interactions of the plurality of relevant user interactions. The transmitting may include transmitting the timestamps in connection with the recorded indications of the input signals of the plurality of relevant user interactions.

### BRIEF DESCRIPTION OF THE FIGURES

The accompanying drawings illustrate one or more embodiments and/or aspects of the disclosure and, together with the written description, serve to explain the principles of the disclosure. Wherever possible, the same reference numbers are used throughout the drawings to refer to the same or like elements of an embodiment, and wherein:

FIG. 1 illustrates an environment in which one or more example embodiments may be implemented.

FIG. 2 is a flowchart illustrating a method according to an example embodiment.

FIG. 3 is a flowchart illustrating a method according to an example embodiment.

FIG. 4 is a block diagram of an illustrative computer system architecture according to an example implementation.

### DETAILED DESCRIPTION

According to some implementations of the disclosed technology, a software test may be generated by recording user interactions with a software program, capturing the software program's responses to the user interactions, and storing the user interactions, responses, and timestamps to be replayed and compared at a later date. The recording may be initiated by an external system, such as a backend server that provides certain functionality to the software program. According to some implementations of the disclosed technology, a software test may be executed by replaying stored user interactions on a software program, capturing the software program's responses to the replayed user interactions, and determining whether the captured responses are consistent with expected responses.

Example implementations of the disclosed technology will now be described with reference to the accompanying figures.

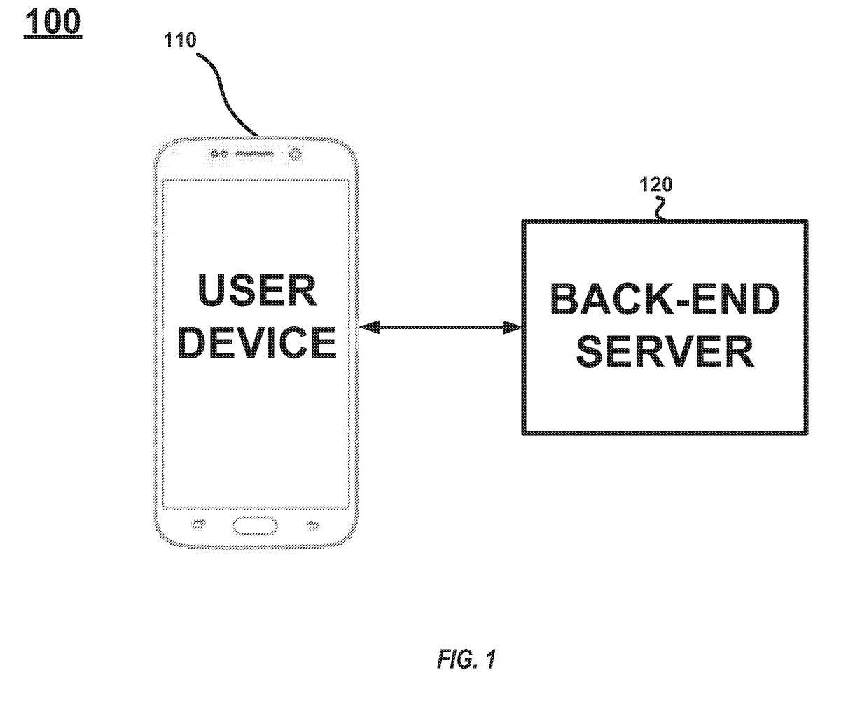

FIG. 1 illustrates a system in which one or more examples of the disclosed technology may be implemented. It will be understood that the system 100 is provided as an example only, and does not limit the scope of the various implementations of the present disclosed systems and methods.

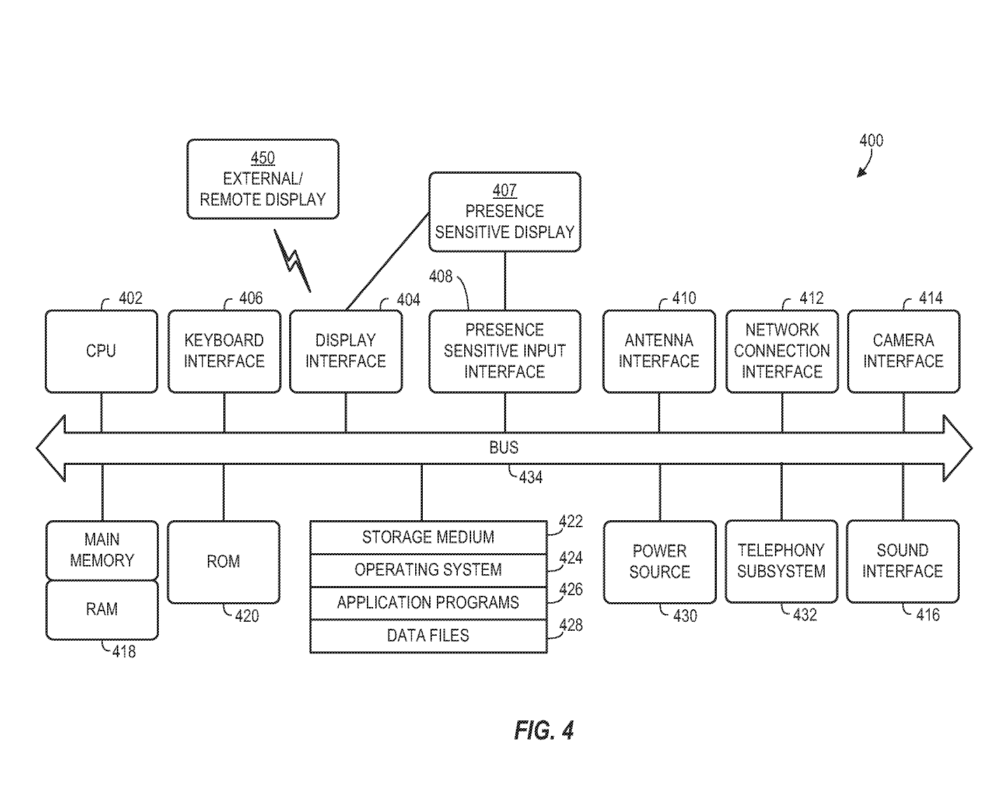

Referring to FIG. 1, the system 100 may include a user device 110 and a backend server 120. According to some implementations, as non-limiting examples, the user device 110 and the backend server 120 may be respective computing devices and may include a personal computer (PC), a mobile computer, a laptop, a desktop, a Smartphone, and one or more distinct server machines. An example of a computer architecture that may be used to implement one or more of the user device 110 and the backend server 120 will be discussed below with reference to FIG. 4.

According to some embodiments, the user device 110 executes a software application in a device environment. A user of user device may interact with the software program through one or more user interfaces. In response to this user interaction, the software program may generate output artifacts. In some cases, the backend server 120 may provide functionality, services, or support to the software program. For example, the backend server 120 may provide login functionality or perform processing in lieu of the user device 110.

The user device 110 may implement an action recorder to record data indicating user interactions with the user interfaces of the software program. As non-limiting examples, the action recorder may record input to a touch screen, keyboard inputs, or mouse inputs, such as press, scroll, and swipe. The action recorder may also record a timestamp of a time of each user interaction in association with the user interaction. In some cases, the action recorder may only record a subset of a plurality of user interactions as relevant user interactions. In some embodiments, the action recorder may record data corresponding to input signals transmitted to or received by the software program. For example, the action recorder may record the input signals as they are transmitted between a physical user interface of the user device 110, e.g., a touch screen, a keyboard, or a mouse, and the software program.

The user device 110 may further implement an output recorder that captures output artifacts generated by the software program in response to the user interactions. The user device 110 may store the recorded user interactions, timestamps, and output artifacts in association with each other. In some cases, the action recorder and the output recorder may be initiated from a device external to the user device 110, for example, by the backend server 120. In some cases, the action recorder and the output recorder may be initiated in response to a request from an external system, such as the backend server 120.

In some cases, the recorded data may be stored in a table, such as Table 1, below.

TABLE 1

| Action | Timestamp | Output Artifact |
|---|---|---|
| A1 | T1 | O1 |
| A2 | T2 | O2 |
| A3 | T3 | O3 |
| . . . | . . . | . . . |
| An | Tn | On |

As a non-limiting example, relevant user interactions may only be user interactions in response to which the software program generates output artifacts.

The user device 110 may further implement a record reader that retrieves the stored user interactions, timestamps, and output artifacts, and a record player to replay the user interactions by simulating the user interactions in an order based on the corresponding time stamps. The user device 110 may implement a replay monitor to monitor the replay of the user interaction by the record reader. The record reader may sequentially replay the user interactions, and the replay monitor may compare the actual output, e.g., output artifacts generated by the software program in response to the replayed action, with the corresponding expected output, e.g., output artifact captured by the output recorder.

In some embodiments, the replay monitor may determine whether the actual output is consistent with the expected output. For example, in a case where the software program is a calendar program, the action recorder may record a user's input adding an event in the next hour. The output recorder may record an output of an event scheduled on a first date at a first time. When the user interaction is replayed, the replay monitor may detect an actual output of an event scheduled on a second date at a second time. The replay monitor may be configured to determine that the actual output is consistent with the expected output even though the dates and times are different based on the context of the capturing and replaying.

As another example, in a case where the software program is a contacts application, the action recorder may be sending a message to a third contact in a contact list. The output recorder may record an output of a message to a particular contact listed third at the time of the recording. When the user interaction is replayed, the replay monitor may detect an actual output of a message to a different contact listed third in a contact list at the time of the replaying. The replay monitor may be configured to determine that the actual output is consistent with the expected output even though the two contacts are different based on the context of the capturing and replaying.

In some cases, the replay monitor may parse data from the expected outcome and the actual outcome, and compare fields derived from the parsed data. In some cases, the replay monitor may be configured by a developer to identify fields or portions of outcomes that should be compared, or fields that may be contextualized. Based on the configurations, the replay monitor may be able to determine what differences between the actual outcome and the expected outcome are consistent and should be ignored.

In some cases, the user device 110 may be a plurality of user devices 110. A first user device 110 may implement the action recorder and the output recorder, and a second user device 110 may implement the record reader and the replay monitor. In some cases, one or more of the action recorder, the output recorder, the record reader, and the replay monitor may be implemented by an external device configured to monitor or manipulate the user device 110. In some embodiments, the record reader and the replay monitor are only utilized after a change to one or more of the software program, the backend server 120, or the device environment of the user device 110. In some cases, one or more of the user device 110 and the backend server 120 may be implemented using a virtual machine on a computer architecture.

In some cases, one or more changes to the software program, the backend server 120, or the device environment of the user device 110 may be simulated, for example, by executing the software program in a virtual machine on the user device 110. One or more of the action recorder, the output recorder, the record reader, and the replay monitor may be implemented as part of the virtual machine.

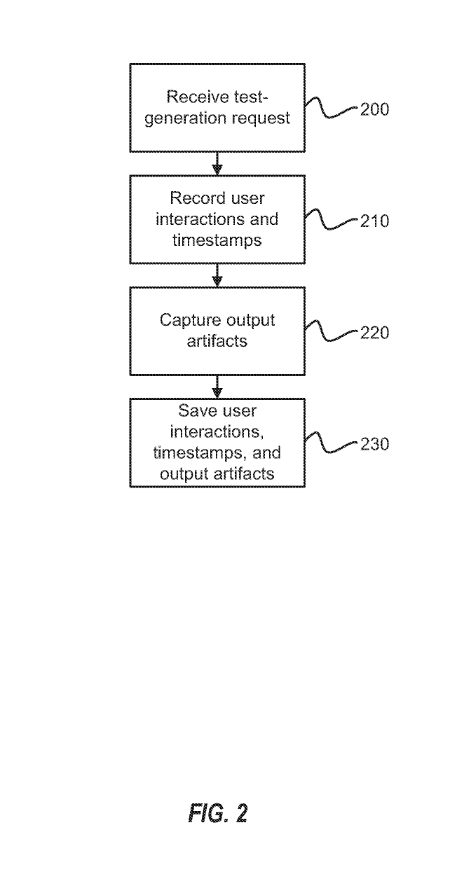

FIG. 2 is a flowchart illustrating a method according to an example embodiment. According to some embodiments, the method illustrated in FIG. 2 may be referred to as a recording phase, a test generation phase, or Phase 1.

In FIG. 2, a computing device, such as the user device 110, receives 200 a test-generation request to record user interactions with a software program. For example, the test-generation request may be received from the backend server 120. In some cases, the test-generation request may be initiated through the software program to be monitored.

The computing device records 210 user interactions with the software program, for example, a client application. The user interactions may be performed on a user interface in the client application. The computing device may also record 210 timestamps corresponding to the time when respective user interactions occur. In some cases, the software program may be executed in a controlled environment and the recording 210 may occur in the controlled environment. The recording 210 may be performed by an action recorder implemented by the computing device.

The computing device captures 220 output artifacts generated after the user interactions. For example, the computing device may capture 220 at least one of graphical information output by the software program and data output or received by the software program. According to some embodiments, the computing device may implement an output recorder that captures the output artifacts.

The computing device saves 230 the user interactions, timestamps, and output artifacts, i.e., recorded data. The recorded data may be saved 230 as a test case. For example, the user interactions may be stored in a manner as to allow the user interactions to be replayed, and the timestamps may determine an order by which the user interactions are to be replayed. The output artifacts may be saved 230 corresponding to respective user interactions as “expected results” to replaying of the respective user interactions.

As a non-limiting example, the software application may be a calendar application. The user interactions may be creating a new event and may be broken down into four interactions: 1) selecting a “Create Event” button; 2) selecting an event name field; 3) entering an event name “New Event” in the event name field; and 4) saving the event. The timestamps may be absolute timestamps, e.g., a time in a world-clock, or relative timestamps, e.g., first, second, third, fourth, etc. In this example, the output artifacts may be: 1) navigating to an event page; 2) event name becoming highlighted as an active field; 3) “New Event” being entered into the event name field; and 4) navigating to the calendar page with a dialogue indicated an “event added” to a first date and time. The interactions, timestamps, and output artifacts may be saved as follows in Table 2:

TABLE 2

| Action | Timestamp | Output Artifact |
|---|---|---|
| Select Create Event | First | Event Page Navigation |
| Select Event Name | Second | Event Name Field Highlighted |
| Field | | |
| Enter “New Name” | Third | “New Event” in Event Name Field |
| Save Event | Fourth | Calendar Navigation; Event Added |
| | | Date1, Time1 Dialogue |

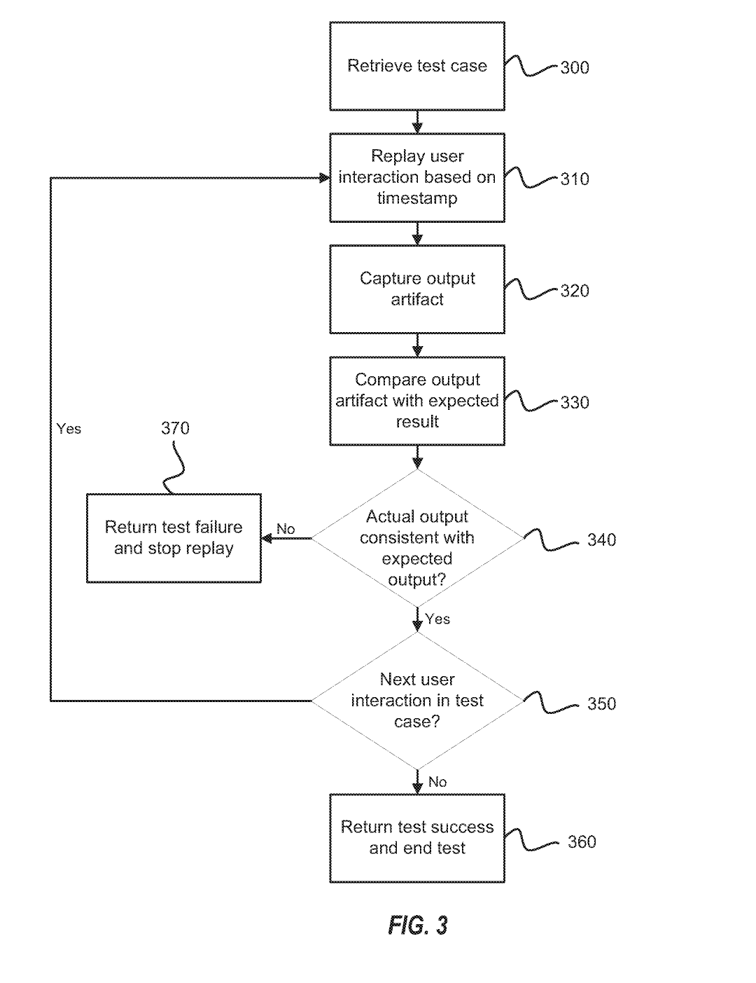

FIG. 3 is a flowchart illustrating a method according to an example embodiment. According to some embodiments, the method illustrated in FIG. 3 may be referred to as a replay phase, a testing phase, or Phase 2.

In FIG. 3, a computing device, such as the user device 110, retrieves 300 a test case. For example, the user device may retrieve saved user interactions, time stamps, and output artifacts generated during Phase 1. In some cases, the testing phase may be initiated in response to a request received from the backend server 120. In some cases, the computing device may initiate a record reader to retrieve 300 the test case.

The computing device replays 310 the retrieved user interactions. The computing device may replay 310 the user interactions sequentially in an order based on the timestamps. In some cases, the computing device may initiate a record player to replay 310 the user interactions. In some embodiments, the record player may transmit data corresponding to input signals transmitted to the software program to replay 310 the user interactions. For example, the record player may transmit the input signals mimicking signals transmitted from a physical user interface of the computing device, e.g., a touch screen, a keyboard, or a mouse, to the software program.

The computing device captures 320 output artifacts generated by the software program in response to the replayed user interactions. The capturing 320 of the output artifacts may be similar to the capturing 220 performed during Phase 1.

The computing device compares 330 the output artifacts captured during the capturing 320 with a corresponding retrieved output artifact. The retrieved output artifacts may be expected outputs for the corresponding replayed user interactions and the output artifacts captured during the capturing 320 may be the actual outputs.

The computing device may determine 340 whether the actual output is consistent with the expected output. For example, in some software programs certain portions of the output are expected to differ between a user interaction during a first time period and the user interaction during a second time period. The computing device may determine 340 whether the actual output is consistent with the expected output by taking into account the expected changes. In some cases, the computing device may implement a replay monitor that captures 320 the output artifacts, compares 330 the actual results to the expected results, and determines 340 whether the actual results are consistent with the expected results. If the actual output is consistent, the computing device determines 350 whether a next user interaction exists in the test case. If a next user interaction exists, the next user interaction is replayed 310. If a next user interaction does not exist, the replay monitor may return 360 a test success and end the test.

As illustrated in the example, the replay monitor may determine whether an actual output is consistent with an expected output before a next user interaction is replayed. Once all user interactions are replayed and the actual outputs are compared with the expected outputs, the computing device may notify 360 of test success and end the test. If an actual output is not consistent with the expected output, the computing device may notify 370 of test failure and stop replay. If the replay fails for some reason, e.g., crashing of the software program, the computing device may stop replay and return test failure.

As a non-limiting example, consider the test case discussed above with reference to Table 2, where the software application is a calendar application and the user interactions create a new event. The record reader may retrieve 300 the entries from Table 2. The record player may then sequentially replay 310 the user interactions based on the timestamps. For example, the record player first replays 310 the “Select Create Event” action. The replay monitor monitors the calendar application and captures 320 an “Event Page Navigation” output artifact. The replay monitor compares 330 the “Event Page Navigation” to the output artifact corresponding to the “Select Create Event” action. Since the actual output is the same as the expected output, the replay monitor determines 340 that the actual output is consistent with the expected output.

Since a next user interaction exists 350, the record player performs 310-350 with the “Select Event Name Field” user interaction and the “Enter ‘New Name’” user interaction. After both events, because the actual output is the same as the expected output, the replay monitor determines 340 that the actual output is consistent with the expected output.

Finally, the record player replays 310 the “Save Event.” The replay monitor captures 320 output artifacts of navigating to the calendar page with “event added” dialogue to a second date and time. The replay monitor compares 330 the captured output artifacts to the expected output artifacts. In this case, the actual output, i.e., the dialogue, has a different date and time from the expected output. However, since, in the context of this test case in the calendar application, the date and time are expected to be dynamic, the replay monitor again determines 340 that the actual output is consistent with the expected output. Since all user interactions have been replayed 350, the computing device returns 360 the test success and ends the test.

FIG. 4 is a block diagram of an illustrative computer system architecture 400, according to an example implementation. For example, the user device 110 and the backend server 120 may be implemented using one or more elements from the computer system architecture 400. It will be understood that the computing device architecture 400 is provided for example purposes only and does not limit the scope of the various implementations of the present disclosed systems, methods, and computer-readable mediums.

The computing device architecture 400 of FIG. 4 includes a central processing unit (CPU) 402, where computer instructions are processed, and a display interface 404 that acts as a communication interface and provides functions for rendering video, graphics, images, and texts on the display. In certain example implementations of the disclosed technology, the display interface 404 may be directly connected to a local display, such as a touch-screen display associated with a mobile computing device. In another example implementation, the display interface 404 may be configured for providing data, images, and other information for an external/remote display 450 that is not necessarily physically connected to the mobile computing device. For example, a desktop monitor may be used for mirroring graphics and other information that is presented on a mobile computing device. In certain example implementations, the display interface 404 may wirelessly communicate, for example, via a Wi-Fi channel or other available network connection interface 412 to the external/remote display 450.

In an example implementation, the network connection interface 412 may be configured as a communication interface and may provide functions for rendering video, graphics, images, text, other information, or any combination thereof on the display. In one example, a communication interface may include a serial port, a parallel port, a general purpose input and output (GPIO) port, a game port, a universal serial bus (USB), a micro-USB port, a high definition multimedia (HDMI) port, a video port, an audio port, a Bluetooth port, a near-field communication (NFC) port, another like communication interface, or any combination thereof. In one example, the display interface 404 may be operatively coupled to a local display, such as a touch-screen display associated with a mobile device. In another example, the display interface 404 may be configured to provide video, graphics, images, text, other information, or any combination thereof for an external/remote display 450 that is not necessarily connected to the mobile computing device. In one example, a desktop monitor may be used for mirroring or extending graphical information that may be presented on a mobile device. In another example, the display interface 404 may wirelessly communicate, for example, via the network connection interface 412 such as a Wi-Fi transceiver to the external/remote display 450.

The computing device architecture 400 may include a keyboard interface 406 that provides a communication interface to a keyboard. In one example implementation, the computing device architecture 400 may include a presence-sensitive display interface 408 for connecting to a presence-sensitive display 407. According to certain example implementations of the disclosed technology, the presence-sensitive display interface 408 may provide a communication interface to various devices such as a pointing device, a touch screen, a depth camera, etc. which may or may not be associated with a display.

The computing device architecture 400 may be configured to use an input device via one or more of input/output interfaces (for example, the keyboard interface 406, the display interface 404, the presence sensitive display interface 408, network connection interface 412, camera interface 414, sound interface 416, etc.) to allow a user to capture information into the computing device architecture 400. The input device may include a mouse, a trackball, a directional pad, a track pad, a touch-verified track pad, a presence-sensitive track pad, a presence-sensitive display, a scroll wheel, a digital camera, a digital video camera, a web camera, a microphone, a sensor, a smartcard, and the like. Additionally, the input device may be integrated with the computing device architecture 400 or may be a separate device. For example, the input device may be an accelerometer, a magnetometer, a digital camera, a microphone, and an optical sensor.

Example implementations of the computing device architecture 400 may include an antenna interface 410 that provides a communication interface to an antenna; a network connection interface 412 that provides a communication interface to a network. As mentioned above, the display interface 404 may be in communication with the network connection interface 412, for example, to provide information for display on a remote display that is not directly connected or attached to the system. In certain implementations, a camera interface 414 is provided that acts as a communication interface and provides functions for capturing digital images from a camera. In certain implementations, a sound interface 416 is provided as a communication interface for converting sound into electrical signals using a microphone and for converting electrical signals into sound using a speaker. According to example implementations, a random access memory (RAM) 418 is provided, where computer instructions and data may be stored in a volatile memory device for processing by the CPU 402.

According to an example implementation, the computing device architecture 400 includes a read-only memory (ROM) 420 where invariant low-level system code or data for basic system functions such as basic input and output (I/O), startup, or reception of keystrokes from a keyboard are stored in a non-volatile memory device. According to an example implementation, the computing device architecture 400 includes a storage medium 422 or other suitable type of memory (e.g. such as RAM, ROM, programmable read-only memory (PROM), erasable programmable read-only memory (EPROM), electrically erasable programmable read-only memory (EEPROM), magnetic disks, optical disks, floppy disks, hard disks, removable cartridges, flash drives), where the files include an operating system 424, application programs 426 (including, for example, a web browser application, a widget or gadget engine, and or other applications, as necessary) and data files 428 are stored. According to an example implementation, the computing device architecture 400 includes a power source 430 that provides an appropriate alternating current (AC) or direct current (DC) to power components.

According to an example implementation, the computing device architecture 400 includes a telephony subsystem 432 that allows the device 400 to transmit and receive sound over a telephone network. The constituent devices and the CPU 402 communicate with each other over a bus 434.

According to an example implementation, the CPU 402 has appropriate structure to be a computer processor. In one arrangement, the CPU 402 may include more than one processing unit. The RAM 418 interfaces with the computer bus 434 to provide quick RAM storage to the CPU 402 during the execution of software programs such as the operating system application programs, and device drivers. More specifically, the CPU 402 loads computer-executable process steps from the storage medium 422 or other media into a field of the RAM 418 in order to execute software programs. Data may be stored in the RAM 418, where the data may be accessed by the computer CPU 402 during execution.

The storage medium 422 itself may include a number of physical drive units, such as a redundant array of independent disks (RAID), a floppy disk drive, a flash memory, a USB flash drive, an external hard disk drive, thumb drive, pen drive, key drive, a High-Density Digital Versatile Disc (HD-DVD) optical disc drive, an internal hard disk drive, a Blu-Ray optical disc drive, or a Holographic Digital Data Storage (HDDS) optical disc drive, an external mini-dual in-line memory module (DIMM) synchronous dynamic random access memory (SDRAM), or an external micro-DIMM SDRAM. Such computer readable storage media allow a computing device to access computer-executable process steps, application programs and the like, stored on removable and non-removable memory media, to off-load data from the device or to upload data onto the device. A computer program product, such as one utilizing a communication system may be tangibly embodied in storage medium 422, which may include a machine-readable storage medium.

According to one example implementation, the term computing device, as used herein, may be a CPU, or conceptualized as a CPU (for example, the CPU 402 of FIG. 4). In this example implementation, the computing device (CPU) may be coupled, connected, and/or in communication with one or more peripheral devices, such as display. In another example implementation, the term computing device, as used herein, may refer to a mobile computing device such as a Smartphone, tablet computer, or smart watch. In this example implementation, the computing device may output content to its local display and/or speaker(s). In another example implementation, the computing device may output content to an external display device (e.g., over Wi-Fi) such as a TV or an external computing system.

In example implementations of the disclosed technology, a computing device may include any number of hardware and/or software applications that are executed to facilitate any of the operations. In example implementations, one or more I/O interfaces may facilitate communication between the computing device and one or more input/output devices. For example, a universal serial bus port, a serial port, a disk drive, a CD-ROM drive, and/or one or more user interface devices, such as a display, keyboard, keypad, mouse, control panel, touch screen display, microphone, etc., may facilitate user interaction with the computing device. The one or more I/O interfaces may be used to receive or collect data and/or user instructions from a wide variety of input devices. Received data may be processed by one or more computer processors as desired in various implementations of the disclosed technology and/or stored in one or more memory devices.

One or more network interfaces may facilitate connection of the computing device inputs and outputs to one or more suitable networks and/or connections; for example, the connections that facilitate communication with any number of sensors associated with the system. The one or more network interfaces may further facilitate connection to one or more suitable networks; for example, a local area network, a wide area network, the Internet, a cellular network, a radio frequency network, a Bluetooth enabled network, a Wi-Fi enabled network, a satellite-based network any wired network, any wireless network, etc., for communication with external devices and/or systems.

According to some implementations, the computer program code may control the computing device to receive a test-generation request, record user interactions with timestamps, capture output artifacts, and save the user interactions, timestamps, and output artifacts. According to some implementations, the computer program code may control the computing device to retrieve a test case, sequentially replay user interactions in an order based on timestamps, capture output artifacts, compare the output artifacts with expected results, and determine whether the output artifacts are consistent the expected output.

While certain implementations of the disclosed technology have been described in connection with what is presently considered to be the most practical and various implementations, it is to be understood that the disclosed technology is not to be limited to the disclosed implementations, but on the contrary, is intended to cover various modifications and equivalent arrangements included within the scope of the appended claims and their equivalents. Although specific terms are employed herein, they are used in a generic and descriptive sense only and not for purposes of limitation.

In the foregoing description, numerous specific details are set forth. It is to be understood, however, that implementations of the disclosed technology may be practiced without these specific details. In other instances, well-known methods, structures and techniques have not been shown in detail in order not to obscure an understanding of this description. References to “one implementation,” “an implementation,” “example implementation,” “various implementation,” etc., indicate that the implementation(s) of the disclosed technology so described may include a particular feature, structure, or characteristic, but not every implementation necessarily includes the particular feature, structure, or characteristic. Further, repeated use of the phrase “in one implementation” does not necessarily refer to the same implementation, although it may.

Throughout the specification and the claims, the following terms should be construed to take at least the meanings explicitly associated herein, unless the context clearly dictates otherwise. The term “connected” means that one function, feature, structure, or characteristic is directly joined to or in communication with another function, feature, structure, or characteristic. The term “coupled” means that one function, feature, structure, or characteristic is directly or indirectly joined to or in communication with another function, feature, structure, or characteristic. The term “or” is intended to mean an inclusive “or.” Further, the terms “a,” “an,” and “the” are intended to mean one or more unless specified otherwise or clear from the context to be directed to a singular form.

As used herein, unless otherwise specified the use of the ordinal adjectives “first,” “second,” “third,” etc., to describe a common object, merely indicate that different instances of like objects are being referred to, and are not intended to imply that the objects so described must be in a-given sequence, either temporally, spatially, in ranking, or in any other manner.

This written description uses examples to disclose certain implementations of the disclosed technology, including the best mode, and also to enable any person of ordinary skill to practice certain implementations of the disclosed technology, including making and using any devices or systems and performing any incorporated methods. The patentable scope of certain implementations of the disclosed technology is defined in the claims and their equivalents, and may include other examples that occur to those of ordinary skill. Such other examples are intended to be within the scope of the claims if they have structural elements that do not differ from the literal language of the claims, or if they include equivalent structural elements with insubstantial differences from the literal language of the claims.

What is claimed is:

1. A method comprising:
retrieving, by at least one processor of a computing device, a test case for a software program, the test case comprising indications of input signals of a plurality of user interactions and first output artifacts generated by the software program in response to input signals of respective user interactions of the plurality of first user interactions; and
sequentially replaying, by the computing device, the plurality of user interactions by:
identifying, by the at least one processor, a current user interaction of the plurality of user interactions;
transmitting, by the at least one processor of the computing device and to the software program, data representative of input signals corresponding to the current user interaction, to replay the current user interaction;
comparing, by the at least one processor of the computing device, a current first output artifact of the plurality of first output artifacts with a current second output artifact generated by the software program in response to receiving the data representative of the input signals corresponding to the current user interaction, the current first output artifact corresponding to the current user interactions; and
in response to the at least one processor determining that the replaying of the current user interaction succeeds based on the comparing, identifying a next user interaction as the current user interaction.

2. The method of claim 1, wherein the determining comprises:
determining whether the current second output artifact is consistent with the current first output artifact, and
determining that the replaying of the current user interaction succeeds in response to the comparing indicating that the current second output artifact is consistent with the current first output artifact.

3. The method of claim 2, wherein the sequentially replaying further comprises, responsive to determining that the replaying of the current user interaction succeeds, replaying the next user interaction.

4. The method of claim 2, wherein the determining whether the current second output artifact is consistent with the current first output artifact comprises identifying contextual differences between the current second output artifact and the current first output artifact as expected differences.

5. The method of claim 4, wherein the test case further comprises identification of contextual differences in the output artifacts.

6. The method of claim 1, wherein the determining comprises determining that the replaying of the current user interaction has failed in response to the comparing indicating that the current second output artifact is fundamentally different from the current first output artifact.

7. The method of claim 1, wherein the determining comprises determining that the replaying of the current user interaction has failed in response an error in the software program.

8. The method of claim 1, wherein
the test case further comprises timestamps corresponding to the user interactions of the plurality of user interactions, and
the sequentially replaying comprises sequentially replaying the recorded plurality of user interactions in an order corresponding to the captured timestamps.

9. A system comprising:
a processor; and
a memory having stored thereon computer program code that, when executed by the processor controls the processor to implement:
a record reader configured to retrieve a test case for a software program, the test case comprising indications of input signals of a plurality of user interactions sent to the software program and a plurality of first output artifacts generated by the software program in response to input signals of respective user interactions of the plurality of user interaction;
a record player configured to sequentially replay the plurality of user interactions by:
identifying a current user interaction of the plurality of user interactions;
transmitting, to the software program, data representative of input signals corresponding to the current user interaction, to replay the current user interaction;
comparing, by the computing device, a current first output artifact of the plurality of first output artifacts with a current second output artifact generated by the software program in response to receiving the data representative of the input signals corresponding to the current user interaction, the current first output artifact corresponding to the current user interactions; and
in response to the computing device determining that replaying of the current user interaction succeeds based on the comparing, identifying a next user interaction as the current user interaction.

10. The system of claim 9, wherein the record player is further configured to sequentially replay the plurality of user interactions by, responsive to determining that the replaying of the current user interaction succeeds, replaying the next user interaction.

11. The system of claim 9, wherein the determining comprises:
determining whether the current second output artifact is consistent with the current first output artifact, and
determining that the replaying of the current user interaction succeeds in response to the comparing indicating that the current second output artifact is consistent with the current first output artifact.

12. The system of claim 11, wherein the determining whether the current second output artifact is consistent with the current first output artifact comprises identifying contextual differences between the current second output artifact and the current first output artifact as expected differences.

13. The system of claim 12, wherein the record player is configurable to identify contextual differences.

14. The system of claim 9, wherein the determining comprises determining that the replaying of the current user interaction has failed in response to the comparing indicating that the current second output artifact is fundamentally different from the current first output artifact.

15. The system of claim 9, wherein the record player is further configured to, responsive to determining that the replaying of the current user interaction has failed, output a notice of the failure and cease the sequential replay.

16. The system of claim 9, wherein
the test case further comprises timestamps corresponding to respective user interactions of the plurality of user interactions, and
the record player is configured to sequentially replay the plurality of user interactions in an order corresponding to the captured timestamps.

17. A method comprising:
receiving, by at least one processor of a computing device from an external device, an instruction to generate a test case for a software program;
recording, by the at least one processor of the computing device and in response to receiving the instruction, indications of input signals of a plurality of relevant user interactions with the software program, the recording comprising:
identifying a plurality of user interactions;
determining whether each user interaction of the plurality of identified user interactions is relevant; and
recording only a subset of the plurality of user interactions determined to be relevant as the plurality of relevant user interactions;
capturing, by the at least one processor of the computing device, first output artifacts generated by the software program in response to the input signals of the plurality of relevant user interactions; and
transmitting, by the at least one processor of the computing device and to the external device, the recorded indications of the input signals of the plurality of relevant user interactions in connection with the captured first output artifacts as the generated test case.

18. (canceled)

19. The method of claim 17, wherein the determining comprises determining that an identified user interaction of the plurality of user interactions is relevant in response to the software program generating an output artifact in response to input signals of the identified user interaction.

20. The method of claim 17 further comprising:
recording, by the computer device, timestamps corresponding to respective user interactions of the plurality of relevant user interactions,
wherein the transmitting comprises transmitting the timestamps in connection with the recorded indications of the input signals of the plurality of relevant user interactions.
